(19) United States
(12) Patent Application Publication
(10) Pub. No.: US 2021/0255104 A1
(43) Pub. Date: Aug. 19, 2021

(54) LIGHT EXTINCTION OF FLUORESCENCE FOR COMPOSITION MEASUREMENTS

(71) Applicant: Reflectronics, Inc., Lexington, KY (US)

(72) Inventors: Fred A. Payne, Lexington, KY (US); Samuel James Mullins, Lexington, KY (US)

(21) Appl. No.: 17/178,137

(22) Filed: Feb. 17, 2021

Related U.S. Application Data
(60) Provisional application No. 62/977,967, filed on Feb. 18, 2020.

(51) Int. Cl. G01N 21/64

(52) U.S. Cl. CPC G01N 21/645; G01N 2021/6484

(57) ABSTRACT

An apparatus for determining a concentration of a target fluorescent compound in a solution containing soluble solids or other materials resulting in light extinction, includes an optical probe and a controller. The optical probe includes two arrays of optical detection fibers at different radial distances from a central illuminating fiber or fibers.

### RELATED APPLICATION

This application claims priority to U.S. Provisional Patent Application Ser. No. 62/977,967 filed on Feb. 18, 2020, which is hereby incorporated by reference in its entirety.

### TECHNICAL FIELD

This document relates to a new and improved apparatus and method adapted for determining a concentration of a fluorescent compound in a solution containing soluble solids or other materials resulting in light extinction.

### BACKGROUND

The whey filtration industry needs a method to measure the protein concentration of whey permeate solutions having varying solids concentration. The varying solids concentration affects the fluorescent light extinction properties of the solution. An optical sensor technology for this application must be able to both measure the protein concentration and correct for the varying solids concentration of the whey permeate solution.

The fluorescent sensor technology described in this document accomplishes the objective of measuring protein and correcting for light extinction by directing ultraviolet light into a whey protein solution, exciting the tryptophan, and measuring the generated fluorescent intensity at two radial distances, r1 and r2, from the excitation light.

Previously, fluorescent concentration measurements were limited to the monotonically increasing fluorescent intensity phase until fluorescent intensity reached a maximum. The new and improved apparatus and method described herein dramatically increases the measurement range for concentration of fluorescent compounds by use of the ratio of the fluorescent intensity measurements. The ratio of the two radial fluorescent measurements, F1/F2, increases monotonically with protein concentration to much higher concentrations.

A simple algebraic model uses these two fluorescent intensity measurements and ratios of measurements to determine the protein concentration of the solution corrected for fluorescent light extinction.

This fluorescent measurement technique and simple algebraic model are also applicable to measuring other fluorescent compound concentrations in solutions. This technology provides two unique advantages for concentration measurement of fluorescent compounds. The first is that the measurable concentration range is dramatically increased with the ratio of the two radial fluorescent measurements versus one individual fluorescent measurement. The second is that the radial fluorescent intensity at two radial distances provides the information needed for correcting the concentration for the varying light extinction properties of the solution.

### SUMMARY

In accordance with the purposes and benefits described herein, a new and improved apparatus is provided for determining a concentration of a target fluorescent compound in a solution containing soluble solids or other materials resulting in light extinction. That apparatus comprises an optical probe and a controller.

The optical probe includes: (a) a light source, (b) one or more illuminating fibers delivering excitation light from the light source to the solution, (c) a first photodetector, (d) an optical fiber or a first array of optical detection fibers configured to collect and deliver, to the first photodetector, fluorescent light emitted by the target fluorescent compound in the solution in response to the excitation light, (e) a second photodetector, and (f) a second array of optical detection fibers configured to collect and deliver, to the second photodetector, the fluorescent light emitted by the target fluorescent compound in response to the excitation light wherein the first array of optical detection fibers is arranged in a first concentric circle around the illuminating fibers at a first average radius r1 and the second array of optical detection fibers is arranged in a second concentric circle around the illuminating fiber at a second average radius r2, where r1<r2.

The controller is configured to (i) measure a first fluorescent response F1 of fluorescence intensity from a first data signal received from the first photodetector, (ii) measure a second fluorescent response F2 of fluorescence intensity from a second data signal received from the second photodetector, and (iii) use a ratio of fluorescent responses F1/F2 to convert the measured fluorescence intensities into a measure of light extinction which can be used with an algorithm to determine concentration of the target fluorescent compound in the solution.

In one or more of the many possible embodiments of the apparatus, the apparatus further includes a sapphire window having a first surface oriented toward the illuminating fiber(s), the first array of optical detection fibers and the second array of optical detection fibers and a second surface oriented toward the solution.

In one or more of the many possible embodiments of the apparatus, the light source is an ultraviolet (UV) light source. In one or more of the many possible embodiments of the apparatus, r2 is between 1.1 and 5 times greater than r1.

In at least one particularly useful embodiment of the apparatus, the UV light source generates the excitation light at about 280 nm, the targeted fluorescent compound is tryptophan, and the solution is a whey permeate solution.

In accordance with an additional aspect, a new and improved method of determining a concentration of a target fluorescent compound in a solution containing soluble solids or other materials resulting in light extinction, comprises the steps of: (a) measuring a first fluorescent response F1 of fluorescence intensity from a first data signal received from a first photodetector, (b) measuring a second fluorescent response F2 of fluorescence intensity from a second data signal received from a second photodetector; and (c) using a ratio of the fluorescent responses F1/F2 to convert the measured fluorescence intensities into a measure of light extinction which can be used with an algorithm to determine concentration of the target fluorescent compound in the solution.

In one or more of the many possible embodiments of the method, the method includes the additional step of delivering excitation light from a light source to the solution.

In one or more of the many possible embodiments of the method, the method includes the additional step of using a first array of optical detection fibers configured to collect and deliver, to the first photodetector, fluorescent light emitted by the target fluorescent compound in response to the excitation light.

In one or more of the many possible embodiments of the method, the method includes the additional step of using a second array of optical detection fibers configured to collect and deliver, to the second photodetector, the fluorescent light emitted by the target fluorescent compound in the response to the excitation light wherein the first array of optical detection fibers is arranged in a first concentric circle around the illuminating fiber at a first average radius r1 and the second array of optical detection fibers is arranged in a second concentric circle around the illuminating fiber at a second average radius r2, where r1<r2.

In one or more of the many possible embodiments of the method, the method includes the additional step of directing excitation light at about 280 nm into a whey permeate solution to determine the concentration of the amino acid tryptophan in protein in the whey permeate solution.

In accordance with yet another aspect, the new and improved method of determining a concentration of a fluorescent compound in a solution containing soluble solids or other materials resulting in light extinction comprises the step of using an algebraic model that combines a measure of calibrated fluorescent intensity H1, H2 and (H1−H2) with a measure of calibrated fluorescent light extinction (H1/H2) that were generated using UV light and collected at two different radial distances r1 and r2.

That UV light may be at about 280 nm. That solution may be a whey permeate solution. The fluorescent compound may be the amino acid tryptophan in protein.

In the following description, there are shown and described several preferred embodiments of the apparatus and the method for determining a concentration of a target fluorescent compound in a solution containing soluble solids or other materials resulting in light extinction. As it should be realized, the apparatus and method are capable of other, different embodiments and their several details are capable of modification in various, obvious aspects all without departing from the apparatus and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the patent specification, illustrate several aspects of the apparatus and the method and together with the description serve to explain certain principles thereof.

FIG. 1 is a schematic diagram of the new and improved apparatus that uses a front face optical configuration to determine a concentration of a target fluorescent compound in a solution containing soluble solids or other materials resulting in light extinction.

FIG. 2 is a schematic representation of the optical probe configuration and resulting radial distribution of backradiated fluorescence onto the probe surface.

FIG. 3 is a front elevational view of the optical fiber bundle configuration of one possible embodiment of the optical probe used to measure fluorescence at two different radial distances r1 and r2.

FIG. 4 is a graph illustrating measured fluorescent responses, F1 and F2, at two radial distances r1, and r2, for whey protein isolate (WPI) in water solutions between 0 and 2% protein concentration. The response ratio F1/F2 is also shown.

FIG. 5 is a graphical representation of an array of soluble solids S and true protein P concentrations mixed using a whey permeate, water and WPI for testing.

FIG. 6 is a plot of calibrated fluorescence response H1 measured using fiber bundle R1 as a function of true protein content grouped into approximate solids concentrations.

FIG. 7 is a plot of calibrated fluorescence response H2 measured using fiber bundle R2 as a function of true protein content grouped into approximate solids concentrations.

FIG. 8 is a plot of H1/H2 ratio as a function of true protein content grouped into approximate solids concentrations.

FIG. 9 is a plot of predicted true protein concentration as a function of sample true protein concentration based upon a simple regression model.

Reference will now be made in detail to the present preferred embodiments of the new and improved apparatus and method, examples of which are illustrated in the accompanying drawing figures.

### DETAILED DESCRIPTION

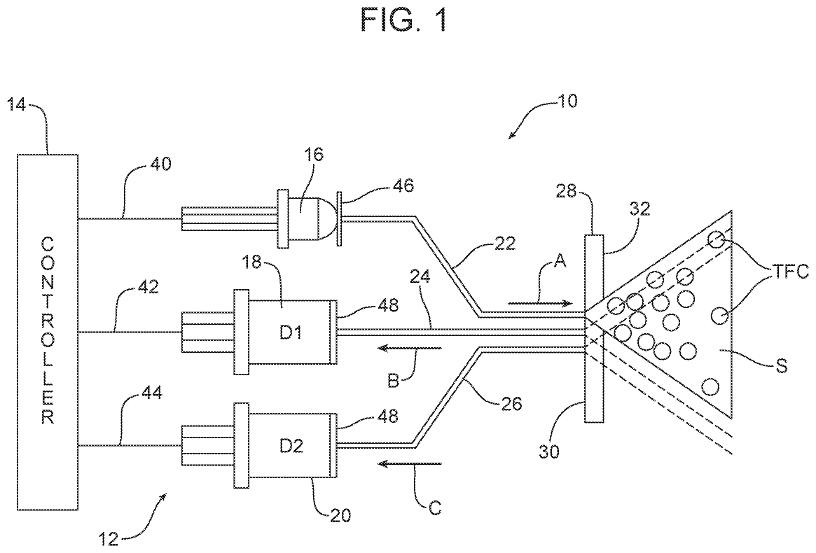

Reference is now made to FIGS. 1-3 that illustrate the new and improved apparatus 10 for determining a concentration of a target fluorescent compound TFC in a solution S containing soluble solids or other materials resulting in light extinction. The apparatus 10 includes an optical probe, generally designated by reference numeral 12, and a controller 14.

More specifically, the optical probe 12 includes a light source 16 of a type known in the art to be useful for producing excitation light at a wavelength that elicits fluorescence from the target fluorescent compound TFC. In one possible embodiment, the light source 16 may be a ultraviolent (UV) light source adapted to produce excitation light/incident radiation at a wavelength of about 280 nm. When contacted with excitation or incident radiation at 280 nm, a target fluorescent compound TFC, such as tryptophan, will absorb such light and fluoresce or emit light at a different wavelength in response.

The optical probe 12 also includes a first photodetector 18 and a second photodetector 20 of a type known in the art and adapted to detect the fluorescence of the target fluorescent compound TFC.

The optical probe 12 also includes at least one illuminating fiber 22, a first array of at least one optical detection fiber 24 and a second array of at least one optical detection fiber 26. The fibers 22, 24 and 26 are all of a type known in the art and adapted for the transmission of light. In the Experimental Section, 22, 24 and 26 are referred to as the Core, R1 and R2 optical bundles.

The at least one illuminating fiber 22 transmits and delivers (note action arrow A) the excitation light generated by the light source 16 to the solution S by projecting that excitation light into the solution held in a vessel (not shown). The first array of optical fibers 24 are configured to collect and deliver to the first photodetector 18, any fluorescent light emitted by the target fluorescent compound TFC in the solution S in response to the excitation light (note action arrow B). Similarly, the second array of optical fibers 26 are configured to collect and deliver to the second photodetector 20, any fluorescent light emitted by the target fluorescent compound TFC in the solution S in response to the excitation light (note action arrow C).

Here it should be noted that the apparatus 10 also includes a sapphire window 28 having (a) a first surface 30 oriented toward the illuminating fibers 22, the first array of optical detection fibers 24 and the second array of optical detection fibers 26 and (b) a second face 32 oriented toward and in contact with the solution S in the vessel. Such a sapphire window 28 is optically transparent at the excitation light wavelength and the fluorescent light wavelength.

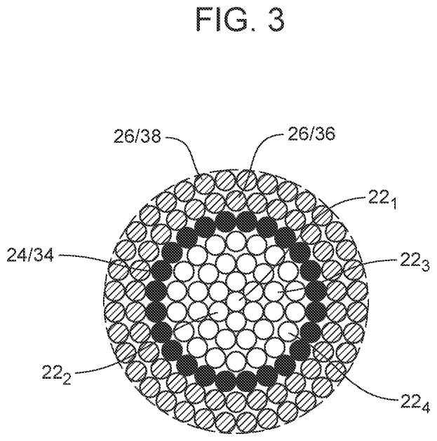

FIG. 3 illustrates a fiber configuration for one possible embodiment of the optical probe 12. In this embodiment, there are thirty-seven illumination fibers 22 including a first illumination fiber 22₁ at the focus or center of the fiber arrangement, a first concentric circle 22₂ of six illumination fibers extending around the first fiber, a second concentric circle 22₃ of twelve illumination fibers extending around the first concentric circle of illumination fibers and a third concentric circle 22₄ of eighteen illumination fibers extending around the second concentric circle of illumination fibers.

The first array of optical detection fibers 24 is arranged in a first concentric circle 34 of twenty-four optical detection fibers extending around the illumination fibers 22/22₁-22₄ at a first average radius or radial distance r1 from the first illumination fiber 22₁ at the focus. The second array of optical detection fibers 26 is arranged in two additional concentric circles: that is, the second concentric circle 36 of thirty optical detection fibers 26 extending around the first concentric circle 34 of optical detection fibers 24 and the third concentric circle 38 of thirty-six optical detection fibers 26 extending around the second concentric circle 36 of optical detection fibers 26.

The optical detection fibers 26 of the second and third concentric circles 36, 38 extend around the illumination fibers 22/22₁-22₄ at a second average radius or radial distance r2 from the first illumination fiber 22₁ at the focus where r1<r2. In one or more embodiments, r2 is between 1.1-5 times greater than r1.

While thirty-seven illumination fibers 22 in three concentric circles are illustrated in FIG. 3, it should be appreciated that other numbers of illumination fibers from 1-n and other numbers of concentric circles of those fibers from 0-m may be provided. While the first array of optical detection fibers 24 illustrated in FIG. 3 includes twenty-four optical detection fibers in one concentric circle 34, it should be appreciated that other numbers of optical fibers from 1-n and other numbers of concentric circles from 1-m may be provided. Similarly, the second array of optical detection fibers 26 illustrated in FIG. 3 includes thirty and thirty-six optical detection fibers in respective concentric circles 36, 38, it should be appreciated that other numbers of optical detection fibers from 1-n and other numbers of concentric circles from 1-m may be provided.

The controller 14 is a computing device of a type known in the art, such as a dedicated microprocessor or electronic control unit operating in accordance with instructions from appropriate control software or hardware. The controller 14 is connected to the light source 16 by the control line 40, the first photodetector 18 by the data line 42 and the second photodetector 20 by the data line 44. The controller controls operation of the light source through the control line 40 and receives optical data from the first and second photodetectors 18, 20 through the respective data lines 42, 44.

The controller 14 is configured or adapted to: (a) measure a first fluorescent response F1 of the fluorescence intensity from a first data signal received from the first photodetector 18 through the data line 42, (b) measure a second fluorescent response F2 of the fluorescence intensity from a second data signal received from the second photodetector 20 through the data line 44, and (c) use a ratio of the fluorescence responses F1/F2 to convert the measured fluorescence intensities into a measure of light extinction which can be used with an algorithm, which may be incorporated into the controller, to determine the concentration of the target fluorescent compound TFC in the solution S.

The apparatus 10 is useful in a method of determining a concentration of a target fluorescent compound TFC in a solution S containing soluble solids or other materials resulting in light extinction. That method includes the steps of: (a) measuring a first fluorescent response F1 of fluorescence intensity from a first data signal received from a first photodetector 18, (b) measuring a second fluorescent response F2 of fluorescence intensity from a second data signal received from a second photodetector 20 and (c) using a ratio of the fluorescent responses F1/F2 to convert the measured fluorescence intensities into a measure of light extinction which can be used with an algorithm to determine the concentration of the target fluorescent compound TFC in the solution S.

The method may include the step of delivering excitation light from the light source 16 to the solution. The method may also include the steps of (a) using the first array of optical detection fibers 24 configured to collect and deliver, to the first photodetector 18, fluorescent light emitted by the target fluorescent compound TFC in response to the excitation light, and (b) using the second array of optical detection fibers 26 configured to collect and deliver, to the second photodetector 20, the fluorescent light emitted by the target fluorescent compound TFC in the response to the excitation light, wherein the first array of optical detection fibers 24 is arranged in a first concentric circle 34 around the illuminating fiber at a first average radius r1 and the second array of optical detection fibers 26 is arranged in a second concentric circle 36 around the illuminating fiber at a second average radius r2, where r1<r2.

In at least one particularly useful embodiment, the method includes the step of directing excitation light at about 280 nm into a whey permeate solution to determine the concentration of the amino acid tryptophan in protein in the whey permeate solution.

Still further, the method includes the step of using an algebraic model that combines a measure of calibrated fluorescent intensity H1, H2 and (H1-H2) with a measure of calibrated fluorescent light extinction (H1/H2) that were generated using UV light and collected at two different radial distances r1 and r2.

### EXPERIMENTAL SECTION

### Introduction

Membrane filters are used in the dairy industry to separate whey proteins from whey. The filters have a definite lifetime with protein losses increasing as the filters degrade with use. The determination of the need for filter replacement can be made by measuring the protein concentration in the whey permeate. An inline sensor is needed to monitor the filter performance and provide an alert should the filtration system fail. The current method for measuring protein concentration in whey permeate is to manually collect samples and use a FTIR analytical instrument to measure the “As-Is” protein concentration. For whey permeate, this “As-Is” measurement includes a significant quantity of non-protein nitrogen (NPN). Typically, whey permeate samples consists of 75% NPN and 25% true protein but the composition varies with the filtration process. Thus, measurement of “true” protein concentration would provide a more precise and economically valuable measure of membrane filter performance. In the following discussion “protein” and “true protein” are synonymous.

### Tryptophan

Three aromatic amino acids (tryptophan, tyrosine, phenylalanine) fluoresce when excited with ultraviolet light. The intrinsic fluorescence of dairy proteins is dominated by tryptophan fluorescence. Dairy proteins contain 2-3% tryptophan. Tryptophan fluorescence is generated by ultraviolet light at 280 nm and the fluorescence spectra has a peak at about 350 nm.

### Soluble Solids Concentration

Whey permeate contains soluble solids composed primarily of lactose (75%) with smaller quantities of protein, non-protein nitrogen compounds, organics, and minerals (calcium, phosphorus, sodium, potassium, chloride). The typical range for soluble solids concentration in whey permeate varies from 1 to 9% depending on the filtration process.

### Protein Concentration

The typical maximum whey permeate protein concentration encountered in whey filtration is about 0.3%. The true protein concentration of the whey permeate solution is desired to be less than 0.05%. A desirable range for a protein concentration sensor is thus between 0.01 and 0.30%. The desirable precision for a whey permeate protein sensor is 0.01%.

### Light Extinction Property

Increasing soluble solids in the whey permeate decreases the penetration depth of ultraviolet light because as solids increase then the concentration of the light extinguishing compounds increase. The light extinction properties of whey permeate are thought to be associated with the non-lactose fraction which is directly proportional to the lactose fraction. The light extinction results from a combination of absorption, scattering, and quenching of the fluorescent light. In the following discussion, the effect of increasing soluble solids is synonymous with increasing the light extinction property.

### Sensor Configuration

The sensor technology for this application uses front face fluorescence as described above and set forth in FIG. 1. The sensor 12 consists of three optical bundles of fibers 22, 24, 26, one excitation bundle 22 and two detection bundles 24, 26 (Core, R1 and R2 fiber bundles, respectively). LED excitation light at 280 nm is directed through a shortpass filter 46; into a bundle of optical fibers 22 (Core fibers); through a sapphire window 28; and into a whey permeate solution S containing target fluorescent compounds TFC. For a whey permeate solution S the UV light excites tryptophan in the protein molecules resulting in a fluorescence spectrum with a peak at about 350 nm.

The two detection bundles 24, 26, containing one or more optical fibers spaced at two different radial distances, r1 and r2, from the center of the excitation fibers 22 are used to measure fluorescent light intensity. The light entering bundles 24, 26 contains reflected, scattered, and fluorescent light. This light is directed through a bandpass filter 48 that passes only fluorescent light between 300 and 475 nm to the individual photodetectors 18 and 20. The fluorescent intensity measurements, F1 and F2, are used to determine the protein concentration of whey permeate solutions.

### Radial Distribution of Fluorescence

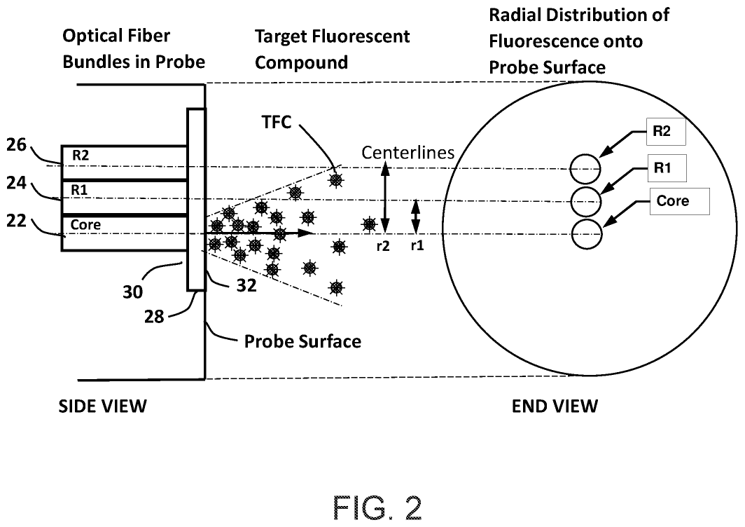

The Core optical fiber bundle 22 positioned along the centerline of the optical probe 12 delivers ultraviolet light from the source 16 to the solution S to excite the target fluorescent compounds TFC. The excited target fluorescent compounds TFC radiate fluorescent light in all directions and create a radial distribution of backradiated fluorescence on the probe 12 and sapphire window surface 32 about the centerline of the Core optical fiber bundle 22. The intensity of the generated fluorescence is decreased by both radial distance and light extinction. Fluorescent light intensity is inversely proportional to the square of the distance. Additionally, light extinction reduces the fluorescent intensity with distance as it passes through the solution S to the optical bundles 24, 26. FIG. 2 illustrates the radial distribution of backradiated fluorescence onto the probe 12 and sapphire window surface 32.

### Optical Fiber Bundle Configuration

A typical configuration of an optical bundle for measuring the intensity of backradiated fluorescence at two radial distances is shown in FIG. 3. The optical fiber bundle configuration has a mean distance r2 greater than r1. The optical bundle in FIG. 3 consists of 127 optical fibers having a diameter of 245 μm. The Core bundle has 37 fibers occupying Rings 0, 1, 2 and 3. Fiber bundle R1 consists of 24 fibers in Ring 4. Fiber bundle R2 consists of 66 fibers in Rings 5 and 6. The fibers have a NA of 0.22.

### Temperature Correction

Measured fluorescence is a function of temperature and increases at about 2%/° C. for tryptophan and whey proteins. Thus, temperature compensation is required to achieve precise compound concentration in processes where the temperature changes significantly. The fluorescence measurements F1 and F2 may be corrected for temperature using a relative fluorescence procedure. The relative fluorescence is standardized to 1 at a reference temperature of 25° C. and can be expressed by the polynomial D(T)=A*T2+B*T+C where A, B, and C are regression coefficients. The temperature correction of measure fluorescence is determined using Equation 1 as follows:

$$\begin{matrix}{G}_{1} = \frac{{F}_{1}}{D ( T )} & Equation 1 a \\ {G}_{2} = \frac{{F}_{2}}{D ( T )} & Equation 1 b\end{matrix}$$

### Reference Fluorescence Intensity

The sensor technology requires calibration to a reference fluorescent intensity to ensure that all sensors deliver the same response. Tryptophan fluorescence was selected as the reference standard. A reference fluorescent intensity was generated by mixing a tryptophan solution, typically 1 ppm, in distilled water and measuring the fluorescent responses TRP₁ and TRP₂ at 25° C. at radial distances, r1 and r2, respectively. The reference fluorescent intensity is then used to calculate the calibrated fluorescent responses, H₁ and H2, using Equation 2 as follows:

$$\begin{matrix}{H}_{1} = \frac{{G}_{1}}{T R {P}_{1}} & Equation 2 a \\ {H}_{2} = \frac{{G}_{2}}{T R {P}_{2}} & Equation 2 b\end{matrix}$$

The range for H₁ and H2 are 0 to 1 if the measurements are within the calibrated concentrations. If the measurement is above the calibrated region, H₁ and H2 exceeds a value of 1.

### Fluorescence Measurement of Protein in an Aqueous Solution

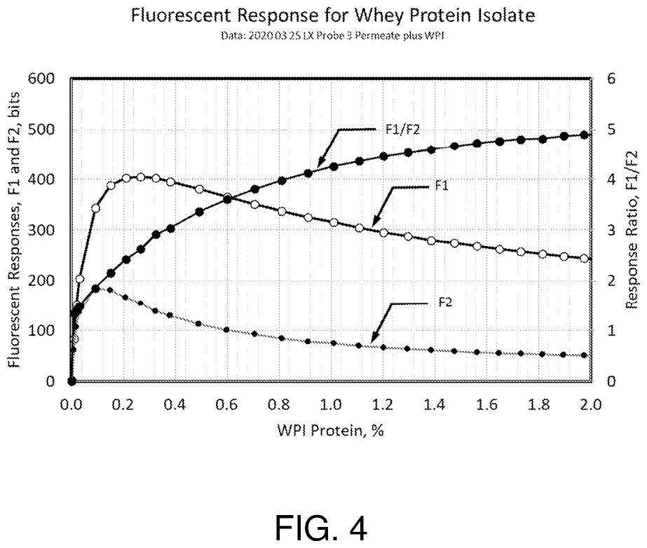

The optical sensor 12 having an arrangement as shown in FIG. 1 with a fiber configuration similar to that shown in FIG. 3 was used to measure the fluorescent responses F₁ and F2 at room temperature for solutions mixed using Whey Protein Isolate (WPI) containing >98% protein and water to obtain samples with different protein concentrations. FIG. 4 shows the measured results of F₁ and F2.

### Measured Responses and Phases

FIG. 4 shows the characteristic response profile for the front face configuration. The measured fluorescence can be divided into two phases: increasing fluorescence with increasing protein concentration; and decreasing fluorescence with increasing protein concentration. The decrease after the peak results because of the increasing light extinction associated with increasing protein concentration. Typically, the peaks for F₁ and F2 occur around a WPI concentration of 0.3% but vary somewhat with different fiber configurations. This same characteristic profile was observed with tryptophan, whey protein, skim milk, whole milk, and red wine.

If a sensor has only one fluorescent measurement such as F₁ to measure compound concentration, then the sensor technology would be limited to the monotonically increasing response range for F₁. The decreasing response phase with increasing compound concentration offers little opportunity for a protein concentration sensor.

FIG. 4 shows the ratio of fluorescent responses, F₁/F₂, increases monotonically well beyond the peak response for F₁ and F₂. Thus, with an appropriate mathematical model, the measured responses F₁, F₂ and F₁/F₂ can be used to determine protein concentrations to 2% or higher. The potential concentration range for a fluorescent concentration measurement is dramatically increased using the ratio of F₁/F₂ (up to 30 times).

Protein Solutions with Soluble Solids

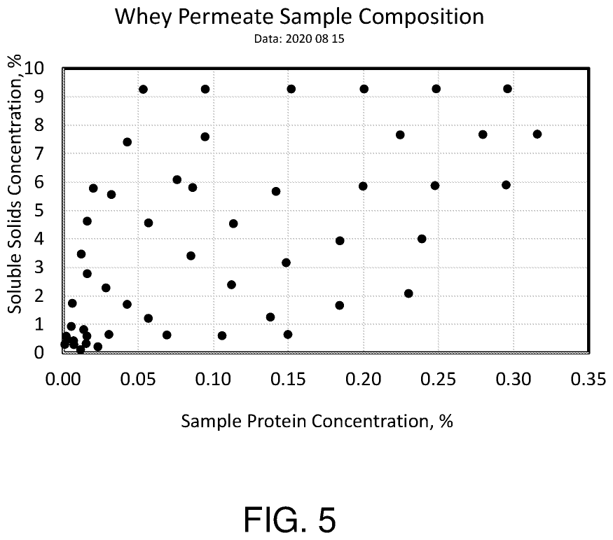

One unique feature of this technology is the measurement of fluorescent compound concentration in solutions that have light extinction caused either by fluorescing or non-fluorescing compounds. This feature was demonstrated by mixing samples using whey permeate (containing soluble solids), water, and WPI to have an array of protein, P, and soluble solids, S, concentrations and measuring F₁ and F₂. FIG. 5 shows the array of S and P concentrations for the mixed samples. The samples contained P between 0 and 0.3% and S between 0 and 10%. These compositions represent the range expected for the whey permeate application. Note that protein is considered a component of soluble solids concentration.

### Test Results

F₁ and F₂ were measured for these samples using a fiber bundle having the configuration as shown in FIG. 3. Tryptophan at a concentration of 1 ppm in water was used as a calibration reference. The measurements were converted to calibrated responses, H₁ and H₂ using Equations 1 and 2 and are presented in FIGS. 5, 6, and 7.

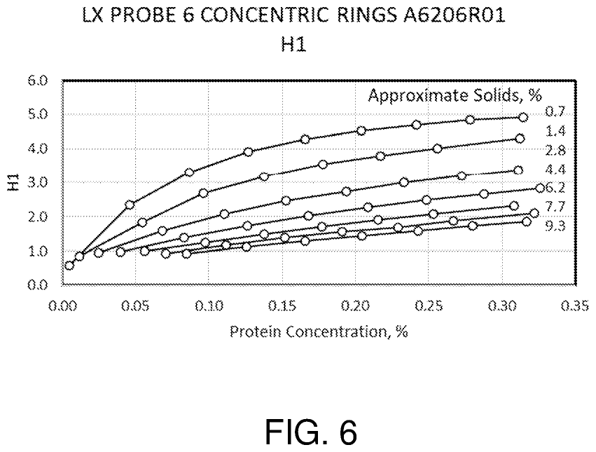

FIG. 6 shows a plot of the calibrated response H₁ as a function of true protein concentration in the mixture and separated at approximate solids concentrations. It is observed that all the curves are monotonically increasing. Thus, the measurements for fiber bundle R1 are in the increasing fluorescence phase.

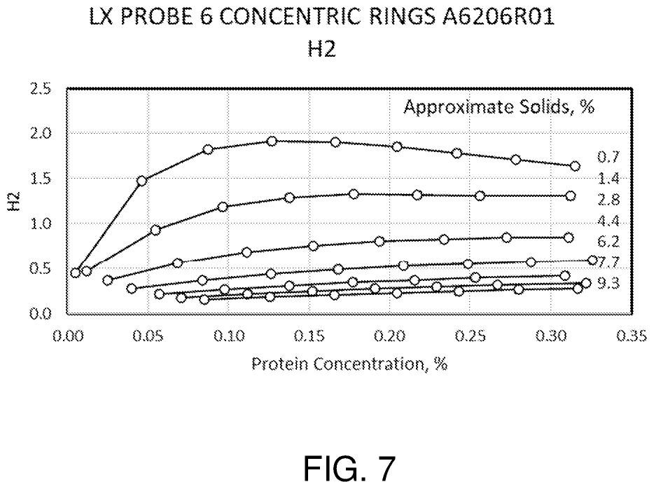

FIG. 7 shows a plot of the calibrated response H₂ as a function of true protein concentration in the mixture and separated at approximate solids concentrations. It is observed that most of the curves are not monotonically increasing. Thus, the measurements for fiber bundle R2 are in both the increasing and decreasing fluorescence phases.

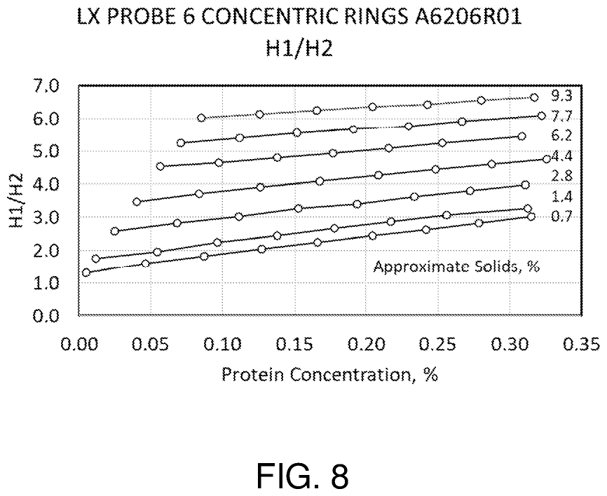

FIG. 8 shows a plot of the ratio of H₁/H₂ as a function of true protein concentration in the mixture and separated at approximate solids concentrations. FIG. 8 clearly demonstrates the benefit of this technology. The ratio of H₁/H₂ is monotonically increasing over the range of proteins for each of the solids concentration.

### Model Development

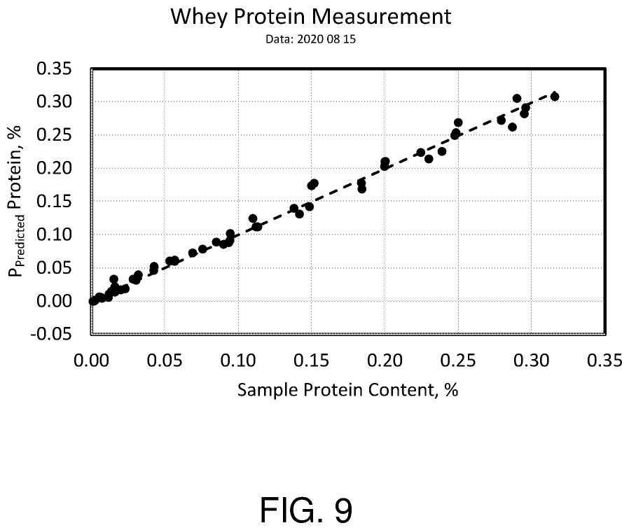

The H₁, H₂, H₁/H₂ and (H₁−H₂) measurements were related to true protein concentration using regression modeling. True protein concentrations and the model's predicted true protein concentrations are shown in FIG. 9.

The value of the technology covered in this document is conclusively demonstrated by the data presented in FIG. 9. The regression model has a SEP of 0.01% protein concentration and thus this precision meets the requirement for measuring true protein concentration in the whey permeate processing application.

### Prediction Models

A simple algebraic model is used to relate true protein concentration in whey permeate to intrinsic tryptophan fluorescence. The independent measurements for developing a model, P_{Predicted}, are H₁, H₂, H₁/H₂ and (H₁−H₂). The variables H₁, H₂ and (H₁−H₂) are measurements of fluorescent intensity as they increase with flux of UV excitation light. The variable H₁/H₂ is a measure of fluorescent light extinction and does not change with an increased flux of UV excitation light. A generalized algebraic model for developing a true protein concentration prediction model is as follows:

$${P}_{Predicted} = {β}_{0} + {β}_{1} {H}_{1} + {β}_{2} {H}_{2} + {β}_{3} ( {H}_{1} - {H}_{2} ) + {{β}_{4} ( H 1 - H 2 )}^{2} + {β}_{5} ( \frac{{H}_{1}}{{H}_{2}} ) + …$$

where β₁-β₅ are regression coefficients.

The appropriate model depends on the probe configuration and range of protein concentration. Generally, only a few terms in the above model are significant. There are numerous regression models that can be developed such as multiple linear regression, nonlinear regression models, polynomial models, etc. This document demonstrates that a simple algebraic expression using the independent variables H₁, H₂, H₁/H₂ and (H₁−H₂) can be regressed to relate fluorescent intensity and fluorescent extinction measurements to true protein concentration corrected for the fluorescent light extinction properties of the solution.

### CONCLUSION

The above tests demonstrate that this technology:

1. greatly expands the range for concentration measurements over which a fluorescent compound concentration can be measured;

2. provides a method for measuring fluorescent compound concentration corrected for the light extinction properties of a solution.

The above clearly describes how the new apparatus 10 and method may be used to determine the concentration of tryptophan in a whey protein permeate solution to benefit the cheese making process. It should be appreciated, however, that the apparatus 10 and method have other applications including, but not necessarily limited to:
Measurement of red wine to guarantee a specific concentration upon dilution with water.
Monitoring the consistency of distillates for whiskey, gin, and other alcoholic beverages and control their dilution with water.
Monitoring fermentations (inline concentration measurements of individual components in a mixture are critical for almost every unit operation in the field of chemical and biotechnological processes).
Online fluorescence for the real-time evaluation of the microbial quality of untreated drinking water (fluorescent dissolved organic matter (DOM) peaks at excitation/emission wavelengths of 280/365 nm); Online fluorescent DOM sensors are a better indicator of the microbial quality of untreated drinking water than turbidity and they have wide-ranging potential applications within the water industry (Reference: Online fluorescence spectroscopy for the real-time evaluation of the microbial quality of drinking water; J. P. R. Sorensena et. al.; Elsevier, Water Research, Volume 137, 15 Jun. 2018, Pages 301-309).
Monitoring rinse water in food processing plants and especially dairy plants for verifying removal of proteins from heat exchangers during CIP (Clean in Place) operations.
Bacteria concentration in the rinse water can be measured using UV fluorescence spectroscopy, a method that is as much as 1000 times more sensitive than absorption spectroscopy. This method is capable of detecting concentrations in the part-per-billion levels.

UVC LED-based instruments can measure the tryptophan response to validate CIP systems to control the duration of cleaning, ensuring the right amount of chemicals are used—not too much, not too little (Reference: Real-Time Process Monitoring in Food and Beverage Manufacturing; https://www.manufacturing.net/operations/article/13162745/realtime-process-monitoring-in-food-and-beverage-manufacturing).

Each of the following terms written in singular grammatical form: “a”, “an”, and the“, as used herein, means “at least one”, or “one or more”. Use of the phrase One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrases: “a unit”, “a device”, “an assembly”, “a mechanism”, “a component, “an element”, and “a step or procedure”, as used herein, may also refer to, and encompass, a plurality of units, a plurality of devices, a plurality of assemblies, a plurality of mechanisms, a plurality of components, a plurality of elements, and, a plurality of steps or procedures, respectively.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The term “method”, as used herein, refers to steps, procedures, manners, means, or/and techniques, for accomplishing a given task including, but not limited to, those steps, procedures, manners, means, or/and techniques, either known to, or readily developed from known steps, procedures, manners, means, or/and techniques, by practitioners in the relevant field(s) of the disclosed invention.

Terms of approximation, such as the terms about, substantially, approximately, etc., as used herein, refers to ±10% of the stated numerical value. Use of the terms parallel or perpendicular are meant to mean approximately meeting this condition, unless otherwise specified.

It is to be fully understood that certain aspects, characteristics, and features, of the apparatus 10 and method, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the apparatus 10 and method which are illustratively described and presented in combination or sub-combination in the context or format of a single embodiment may also be illustratively described and presented in the context or format of a plurality of separate embodiments.

Although the apparatus 10 and method have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. An apparatus for determining a concentration of a target fluorescent compound in a solution containing soluble solids or other materials resulting in light extinction, comprising:
(A) an optical probe including;
(a) a light source,
(b) at least one illuminating fiber delivering excitation light from the light source to the solution,
(c) a first photodetector,
(d) a first array of at least one optical detection fiber configured to collect and deliver, to the first photodetector, fluorescent light emitted by the target fluorescent compound in the solution in response to the excitation light,
(e) a second photodetector, and
(f) a second array of at least one optical detection fibers configured to collect and deliver, to the second photodetector, the fluorescent light emitted by the target fluorescent compound in the response to the excitation light wherein the first array of at least one optical detection fiber is arranged in a first concentric circle around the at least one illuminating fiber at a first average radius r1 and the second array of at least one optical detection fiber is arranged in a second concentric circle around the at least one illuminating fiber at a second average radius r2, where r1<r2; and
(B) a controller configured to (i) measure a first fluorescent response F₁ of fluorescence intensity from a first data signal received from the first photodetector, (ii) measure a second fluorescent response F₂ of fluorescence intensity from a second data signal received from the second photodetector, and (iii) use a ratio of the fluorescent responses F₁/F₂ to convert the measured fluorescence intensities into a measure of light extinction which can be used with an algorithm to determine concentration of the target fluorescent compound in the solution.

2. The apparatus of claim 1, further including a sapphire window having a first surface oriented toward the illuminating fibers, the first array of optical detection fibers and the second array of optical detection fibers and a second surface oriented toward the solution.

3. The apparatus of claim 1, wherein the light source is an ultraviolet (UV) light source.

4. The apparatus of claim 3, wherein r2 is between 1.05 and 5 times greater than r1.

5. The apparatus of claim 3, wherein the UV light source generates the excitation light at about 280 nm, the targeted fluorescent compound is tryptophan, and the solution is a whey permeate solution.

6. A method of determining a concentration of a target fluorescent compound in a solution containing soluble solids or other materials resulting in light extinction, comprising:
measuring a first fluorescent response F₁ of fluorescence intensity from a first data signal received from a first photodetector;
measuring a second fluorescent response F₂ of fluorescence intensity from a second data signal received from a second photodetector; and
using a ratio of the fluorescent responses F₁/F₂ to convert the measured fluorescence intensities into a measure of light extinction which can be used with an algorithm to determine concentration of the target fluorescent compound in the solution.

7. The method of claim 6, including delivering excitation light from a light source to the solution.

8. The method of claim 7, including using a first array of optical detection fibers configured to collect and deliver, to the first photodetector, fluorescent light emitted by the target fluorescent compound in response to the excitation light.

9. The method of claim 8, including using a second array of optical detection fibers configured to collect and deliver, to the second photodetector, the fluorescent light emitted by the target fluorescent compound in the response to the excitation light wherein the first array of optical detection fibers is arranged in a first concentric circle around the illuminating fiber at a first average radius r1 and the second array of optical detection fibers is arranged in a second concentric circle around the illuminating fiber at a second average radius r2, where r1<r2.

10. The method of claim 9, further including directing excitation light at about 280 nm into a whey permeate solution to determine the concentration of the amino acid tryptophan in protein in the whey permeate solution.

11. A method of determining a concentration of a fluorescent compound in a solution containing soluble solids or other materials resulting in light extinction, comprising:
using an algebraic model that combines a measure of calibrated fluorescent intensity H₁, H₂ and (H₁−H₂) with a measure of calibrated fluorescent light extinction (H₁/H₂) that were generated using UV light and collected at two different radial distances r1 and r2.

12. The method of claim 11, wherein the UV light is at 280 nm.

13. The method of claim 12, wherein the solution is a whey permeate solution and the fluorescent compound is the amino acid tryptophan in protein.
